(19) United States
(12) Patent Application Publication
(10) Pub. No.: US 2019/0121763 A1
(43) Pub. Date: Apr. 25, 2019

(54) METHOD FOR COMMUNICATING WITH ANOTHER ELECTRONIC DEVICE AND ASSOCIATED ELECTRONIC DEVICE

(71) Applicant: MEDIATEK INC., Hsin-Chu (TW)

(72) Inventors: Huai-Yuan Feng, Hsinchu County (TW); Yung-Chih Lin, Taipei City (TW); Liang-Yen Wang, New Taipei City (TW); Kai-Sheng Chuang, Hsinchu City (TW); Tsung-Han Wu, Yun-Lin Hsien (TW); Yang-Fan Mu, Taoyuan City (TW); Chia-Chun Wang, New Taipei City (TW)

(21) Appl. No.: 15/790,078

(22) Filed: Oct. 23, 2017

(51) Int. Cl. G06F 13/36; G06F 13/42

(52) U.S. Cl. CPC G06F 13/36; G06F 13/4221; G06F 2213/0026; G06F 2213/0024; G06F 13/4282

(57) ABSTRACT

An electronic device includes a first stream port and a control circuit. The first stream port includes a plurality of lanes, wherein the plurality of lanes are used to couple to a plurality of lanes of a second stream port of another electronic device, respectively. The control circuit is coupled to the first stream port, and is arranged for controlling a data transmission and data reception of the first stream port. When the lanes of the first stream port receive training sequences having a plurality of lane numbers from the lanes of the second stream port, respectively, to initiate a lane number negotiation, the lanes of the first stream port send back the received lane numbers to the second stream port, without considering default lane numbers of the lanes of the first stream port.

### BACKGROUND

In the byte striping rule of the Peripheral Component Interconnect express (PCIe) specification, a packet is transmitted over x1, x2, x4, x16 or x32 lanes of a link. For a multi-lanes application, because a symbol is divided into several parts for transmission, each channel between two chips must have the same lane number for every chip to make sure the receiver side can process the data correctly. Taking a four-lane application as an example, input/output (I/O) terminals having a lane number “0” within a first chip must be connected to I/O terminals having the lane number “0” within a second chip, I/O terminals having a lane number “1” within the first chip must be connected to I/O terminals having the lane number “1” within the second chip, I/O terminals having a lane number “2” within the first chip must be connected to I/O terminals having the lane number “2” within the second chip, and I/O terminals having a lane number “3” within the first chip must be connected to I/O terminals having the lane number “3” within the second chip. However, because the pins/balls arrangements may be different for different chip designs, the aforementioned lane number rule may cause difficult or complicated routings on a printed circuit board (PCB).

### SUMMARY

It is therefore an object of the present invention to provide a multi-lane sequence auto-tuning method, which can function properly even if two chips have different lane numbers for the same channel to make the PCB routing be flexible, to solve the above-mentioned problems.

According to one embodiment of the present invention, an electronic device comprises an upstream port and a control circuit. The upstream port comprises a plurality of lanes, wherein the plurality of lanes are used to couple to a plurality of lanes of a downstream port of another electronic device, respectively. The control circuit is coupled to the upstream port, and is arranged for controlling a data transmission and data reception of the upstream port. When the lanes of the upstream port receive training sequences having a plurality of lane numbers from the lanes of the downstream port, respectively, to initiate a lane number negotiation, the lanes of the upstream port send back the received lane numbers to the downstream port, without considering default lane numbers of the lanes of the upstream port.

According to another embodiment of the present invention, a method for communicating with another electronic device is provided, which comprises: providing an upstream port comprising a plurality of lanes, wherein the plurality of lanes are used to couple to a plurality of lanes of a downstream port of the another electronic device, respectively; receiving training sequences having a plurality of lane numbers from the lanes of the downstream port to initiate a lane number negotiation; and sending back the received lane numbers to the downstream port, without considering default lane numbers of the lanes of the upstream port.

According to another embodiment of the present invention, an electronic device comprises a downstream port and a control circuit. The downstream port comprises a plurality of lanes, wherein the plurality of lanes are used to couple to a plurality of lanes of an upstream port of another electronic device, respectively. The control circuit is coupled to the downstream port, and is arranged for controlling a data transmission and data reception of the upstream port. When the lanes of the downstream port receive training sequences having a plurality of lane numbers from the lanes of the upstream port, respectively, the lanes of the downstream port send back the received lane numbers to the upstream port, without considering default lane numbers of the lanes of the downstream port.

According to another embodiment of the present invention, a method for communicating with another electronic device is provided, which comprises: providing a downstream port comprising a plurality of lanes, wherein the plurality of lanes are used to couple to a plurality of lanes of an upstream port of another electronic device, respectively; receiving training sequences having a plurality of lane numbers from the lanes of the upstream port, respectively; and sending back the received lane numbers to the upstream port, without considering default lane numbers of the lanes of the downstream port.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating an electronic device according to one embodiment of the present invention.

FIG. 2 shows a flow of confirming a link number and lane numbers according to one embodiment of the present invention.

FIG. 3A and FIG. 3B shows a link number negotiation according to one embodiment of the present invention.

FIG. 3C and FIG. 3D shows a lane number negotiation according to one embodiment of the present invention.

FIG. 3E shows a configuration complete state according to one embodiment of the present invention.

FIG. 4 is a diagram illustrating an electronic device according to another embodiment of the present invention.

FIG. 5A-5D shows a lane number negotiation according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

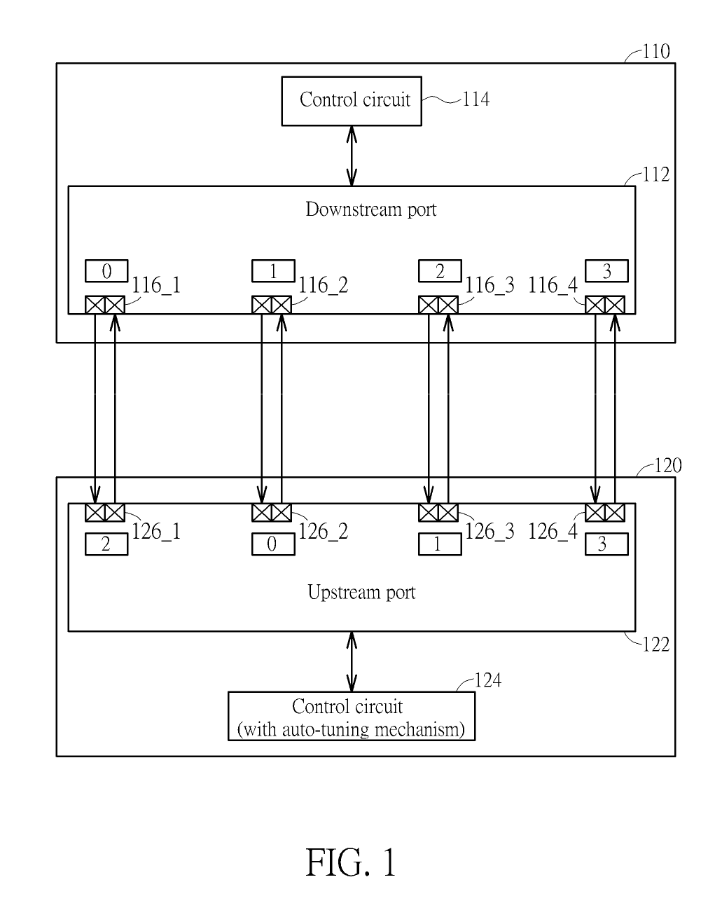

FIG. 1 is a diagram illustrating an electronic device 120 according to one embodiment of the present invention. As shown in FIG. 1, the electronic device 120 is coupled to another electronic device 110 via a plurality of dual channels, and the electronic devices 110 and 120 are communicated via interfaces complied with Peripheral Component Interconnect (PCI), PCI-express (PCIe) or PCIe over MPHY (mPCIe) standard (hereinafter, PCIe is used as an example). In this embodiment, the electronic device 120 comprises an upstream port 122 and a control circuit 124 with auto-tuning mechanism of the present invention, wherein the upstream port 122 serves as an interface circuit complied with the PCIe standard, and the upstream port 122 comprises at least a transaction layer, data link layer and physical layer, and a plurality of I/O terminals 126_1-126_4; and the control circuit 124 is arranged to control data transmission and data reception of the upstream port 122. In addition, because operations of the transaction layer, data link layer and physical layer within the upstream port 122 are known by a person skilled in the art, and the invention does not focus on this circuit elements, further descriptions about the detailed operations within the upstream port 122 is omitted here.

The electronic device 110 comprises a downstream port 112 and a control circuit 114, wherein the downstream port 112 serves as an interface circuit complied with the PCIe standard, and the downstream port 112 comprises at least a transaction layer, data link layer and physical layer, and a plurality of I/O terminals 116_1-116_4; and the control circuit 114 is arranged to control data transmission and data reception of the downstream port 112. In addition, the control circuit 114 may be implemented with or without the auto-tuning mechanism of the present invention.

In this embodiment, the electronic device 110 is communicated with the electronic device 120 via four lanes, wherein each lane represents a dual channel for a differential signal pair, and one pair for transmission and one pair for reception. Specifically, the channels between the I/O terminals 116_1 and 126_1 represents a first lane, the channels between the I/O terminals 116_2 and 126 2 represents a second lane, the channels between the I/O terminals 116_3 and 126_3 represents a third lane, and the channels between the I/O terminals 116_4 and 126_4 represents a fourth lane. In this embodiment, the electronic device 110 and the electronic device 120 provide different default lane numbers for each lane, for example, the electronic device 110 sets the first lane, the second lane, the third lane and the fourth lane to have default lane numbers “0”, “1”, “2”, “3”, respectively; and the electronic device 120 sets the first lane, the second lane, the third lane and the fourth lane to have default lane numbers “2”, “0”, “1”, “3”, respectively.

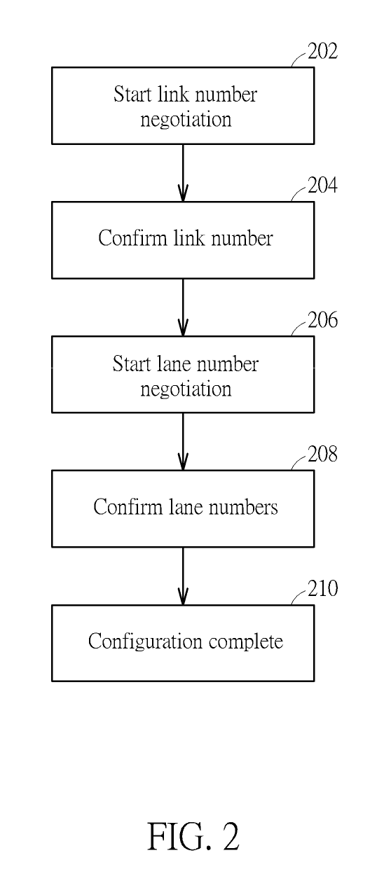

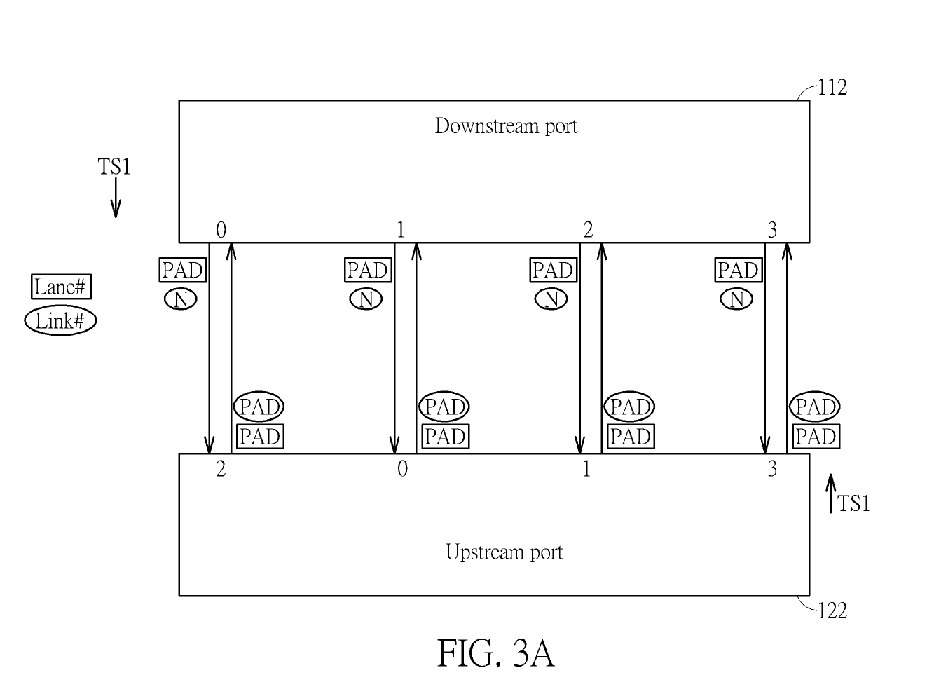

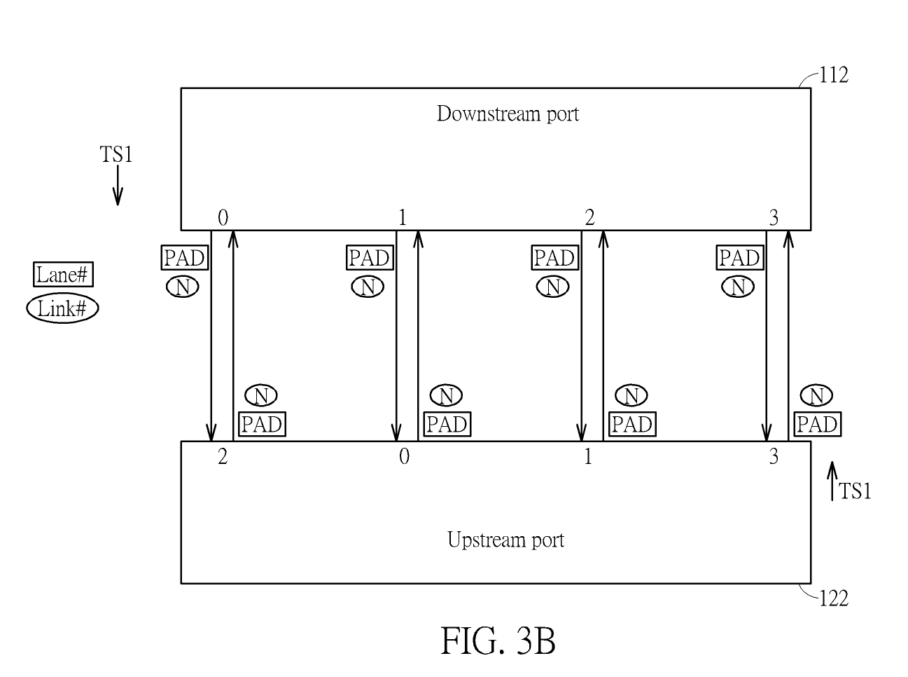

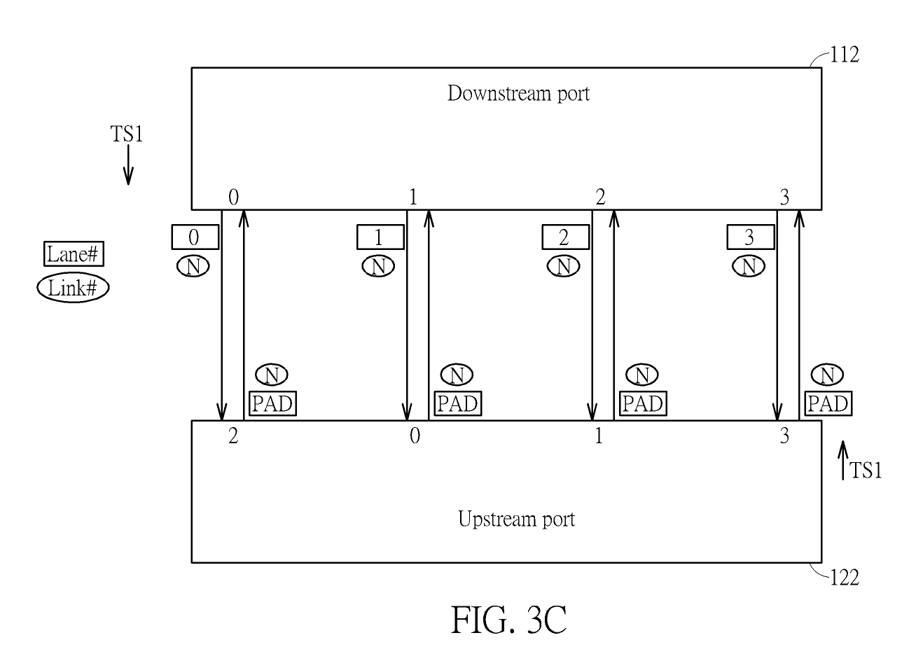

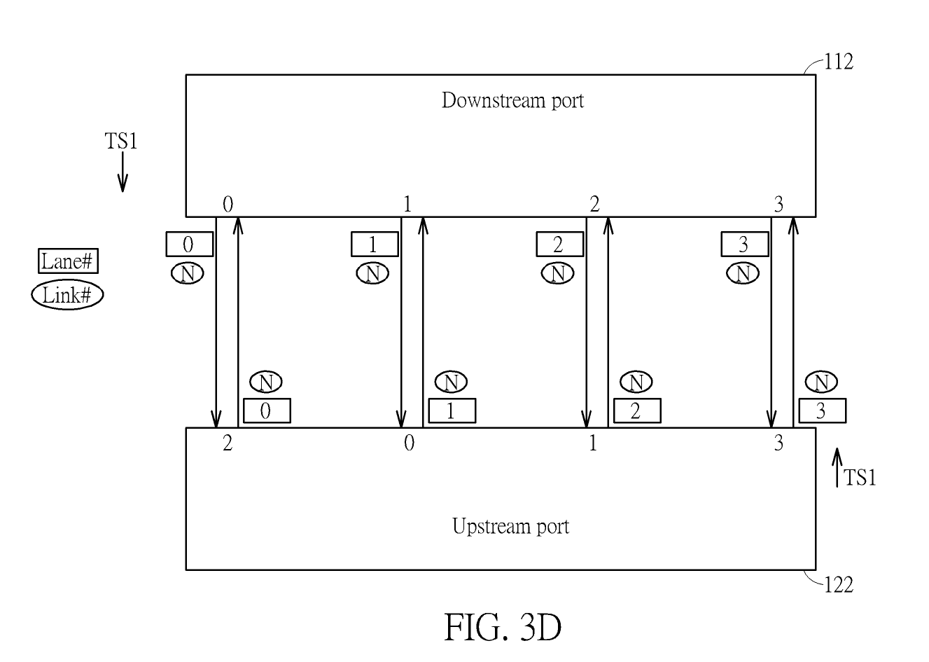

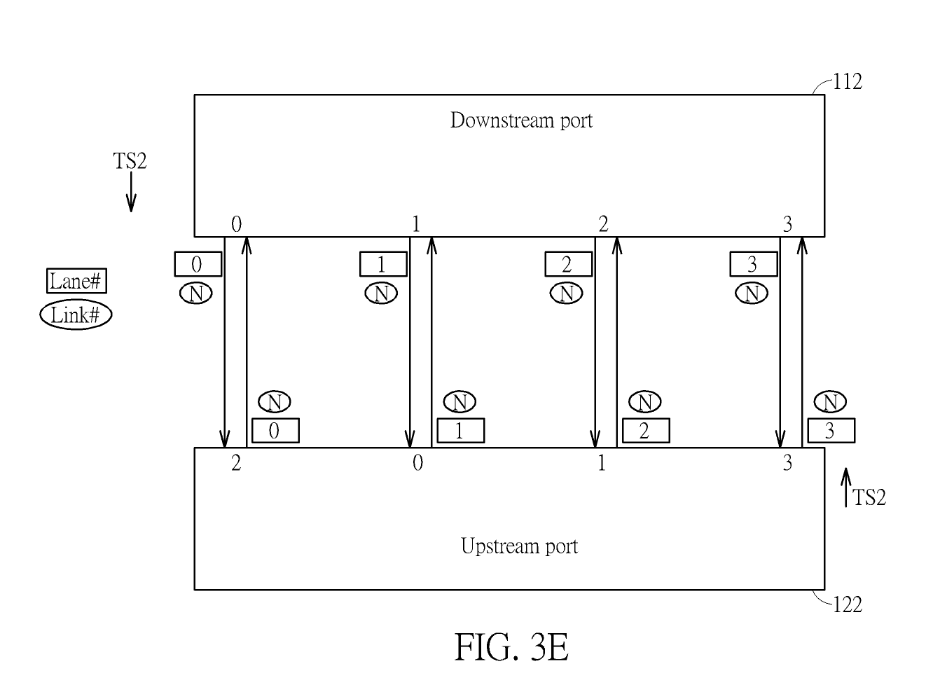

Before the electronic device 110 builds a link with the electronic device 120, the electronic device 110 needs to initiate a link number negotiation and a lane number negotiation to confirm the link number and the lane numbers. FIG. 2 shows a flow of confirming a link number and lane numbers according to one embodiment of the present invention. As shown in FIG. 2, in step 202, the electronic device 110 starts to connect to the electronic device 120 and there is no link between the electronic devices 110 and 120, the control circuit 110 controls the downstream port 112 to transmit a training sequence TS1 to the upstream port 122 within the electronic device 120. As shown in FIG. 3A, the training sequence TS1 comprises a link number “N” and a lane number “PAD”, where the link number “N” can be any valid value, and the lane number “PAD” may be a symbol defined in the PCIe specification. Meanwhile, the control circuit 124 controls the upstream port 122 to transmit the training sequence TS1 having a link number “PAD” and a lane number “PAD” to the downstream port 112.

In Step 204, after receiving the link number “N” from the downstream port 112, the control circuit 124 controls the upstream port 122 to transmit the training sequence TS1 having the link number “N” and the lane number “PAD” to the downstream port 112, as shown in FIG. 3B. Because both the electronic devices 110 and 120 transmit and receive the same link number “N”, the link number “N” is confirmed and the link number negotiation succeeds.

In Step 206, the electronic device 110 starts the lane number negotiation with the electronic device 120. As shown in FIG. 3C, the control circuit 114 controls the downstream port 112 to transmit the training sequence TS1 to the upstream port 122 within the electronic device 120, wherein each training sequence TS1 comprises the link number “N” and a default lane number. For example, the first lane (from left to right) of the downstream port 112 transmits the training sequence TS1 having the link number “N” and a default lane number “0” to the first lane of the upstream port 122, the second lane of the downstream port 112 transmits the training sequence TS1 having the link number “N” and a default lane number “1” to the second lane of the upstream port 122, the third lane of the downstream port 112 transmits the training sequence TS1 having the link number “N” and a default lane number “2” to the third lane of the upstream port 122, and the fourth lane of the downstream port 112 transmits the training sequence TS1 having the link number “N” and a default lane number “3” to the fourth lane of the upstream port 122.

In Step 208, after receiving the lane numbers from the downstream port 112, each lane of the upstream port 122 directly sends back the received lane number to the downstream port 112, without considering its default lane number. As shown in FIG. 3D, the first lane of the upstream port 122 transmits the training sequence TS1 having the link number “N” and the received lane number “0”, instead of the default lane number “2”, to the first lane of the downstream port 112; the second lane of the upstream port 122 transmits the training sequence TS1 having the link number “N” and the received lane number “1”, instead of the default lane number “0”, to the second lane of the downstream port 112; the third lane of the upstream port 122 transmits the training sequence TS1 having the link number “N” and the received lane number “2”, instead of the default lane number “1”, to the third lane of the downstream port 112; and the fourth lane of the upstream port 122 transmits the training sequence TS1 having the link number “N” and the received lane number “3”, which is the same as the default lane number “3”, to the fourth lane of the downstream port 112. Because the electronic device 110 and 120 transmit and receive the same lane number sequence (i.e., “0”, “1”, “2”, and “3”, from left to right), the lane numbers are confirmed and the lane number negotiation succeeds.

In Step 210, each lane of the downstream port 112 and the upstream port 122 repeatedly transmits a training sequence TS2 having the link number “N” and its lane number as shown in FIG. 3E. After each lane receives eight consecutive training sequence TS2 successfully, the PCIe link and lane configuration completes, and the electronic devices 110 and 120 can effectively communicate with each other.

In addition, because the actual lane number sequence of the upstream port 122 is different from the default lane number sequence, the control circuit 124 needs to use the confirmed lane number sequence, instead of the default lane number sequence, to organize/process data received from the downstream port 112.

In the aforementioned embodiment, because the electronic device 120 has the auto-tuning mechanism of the present invention, the actual lane number of each lane of the upstream port 122 can be determined according to the received lane number, without being limited by the default lane number. Therefore, the PCB routing between the electronic devices 110 and 120 can be flexible.

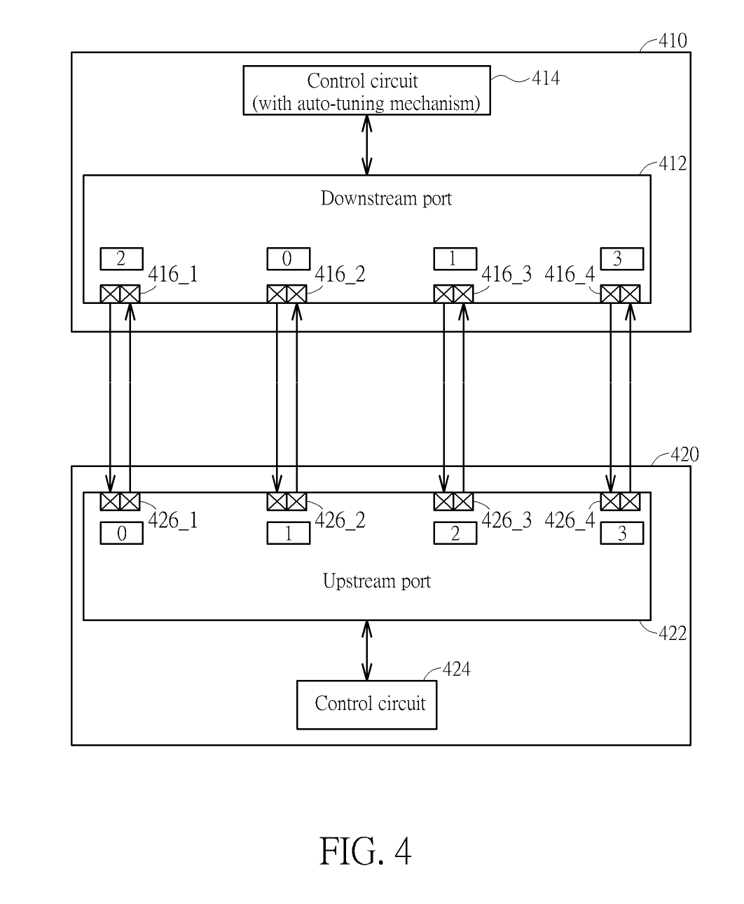

FIG. 4 is a diagram illustrating an electronic device 110 according to one embodiment of the present invention. As shown in FIG. 4, the electronic device 410 is coupled to another electronic device 420 via a plurality of dual channels, and the electronic devices 410 and 420 are communicated via interfaces complied with PCI, PCIe or mPCIe standard (hereinafter, PCIe is used as an example). In this embodiment, the electronic device 410 comprises a downstream port 412 and a control circuit 414 with auto-tuning mechanism of the present invention, wherein the downstream port 412 serves as an interface circuit complied with the PCIe standard, and the downstream port 412 comprises at least a transaction layer, data link layer and physical layer, and a plurality of I/O terminals 416_1-416_4; and the control circuit 414 is arranged to control data transmission and data reception of the downstream port 412. In addition, because operations of the transaction layer, data link layer and physical layer within the downstream port 412 are known by a person skilled in the art, and the invention does not focus on this circuit elements, further descriptions about the detailed operations within the downstream port 412 is omitted here.

The electronic device 420 comprises an upstream port 422 and a control circuit 424, wherein the upstream port 422 serves as an interface circuit complied with the PCIe standard, and the upstream port 422 comprises at least a transaction layer, data link layer and physical layer, and a plurality of I/O terminals 426_1-426_4; and the control circuit 424 is arranged to control data transmission and data reception of the upstream port 422. In this embodiment, the control circuit 424 does not have the auto-tuning mechanism of the present invention.

In this embodiment, the electronic device 410 is communicated with the electronic device 420 via four lanes, wherein each lane represents a dual channel for a differential signal pair, and one pair for transmission and one pair for reception. Specifically, the channels between the I/O terminals 416_1 and 426_1 represents a first lane, the channels between the I/O terminals 416_2 and 426_2 represents a second lane, the channels between the I/O terminals 416_3 and 426_3 represents a third lane, and the channels between the I/O terminals 416_4 and 426_4 represents a fourth lane. In this embodiment, the electronic device 410 and the electronic device 420 provides different default lane numbers for each lane, for example, the electronic device 410 sets the first lane, the second lane, the third lane and the fourth lane to have default lane numbers “2”, “0”, “1”, “3”, respectively; and the electronic device 420 sets the first lane, the second lane, the third lane and the fourth lane to have default lane numbers “0”, “1”, “2”, “3”, respectively.

Before the electronic device 110 builds a link with the electronic device 120, the electronic device 110 needs to initiate a link number negotiation and a lane number negotiation to confirm the link number and the lane numbers. The flow of confirming the link and lane numbers can refer to FIG. 2 again. In the following description, because the link number negotiation (i.e. Step 202 and Step 204) is similar to the embodiment shown in FIG. 3A and FIG. 3B, only the lane number negotiation is provided below.

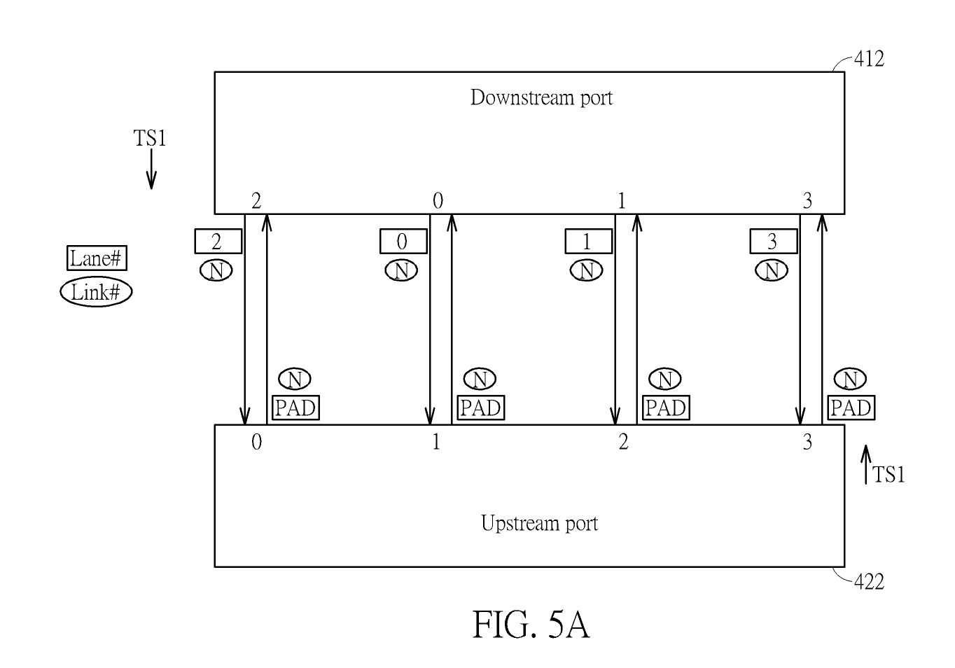

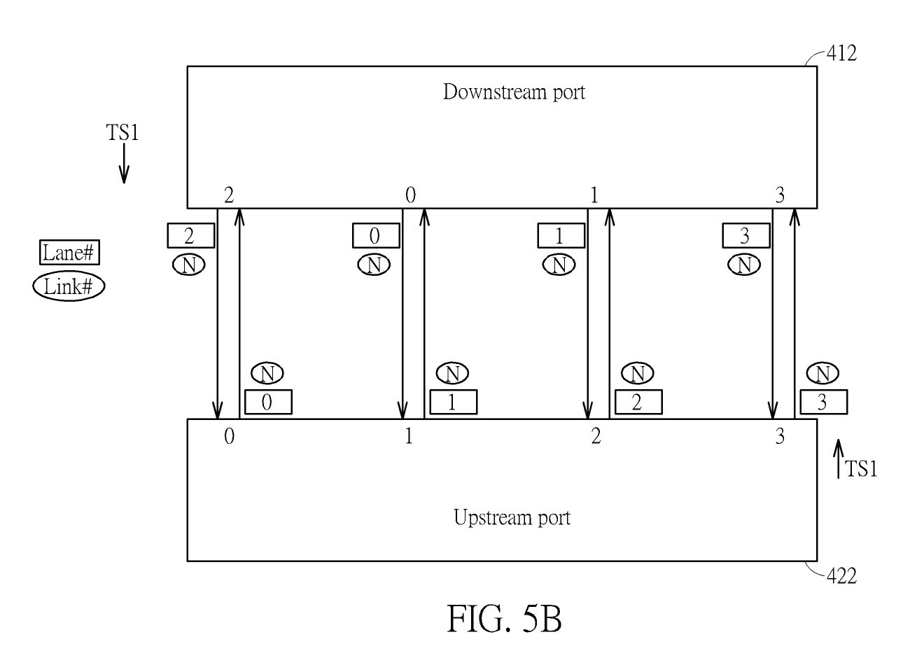

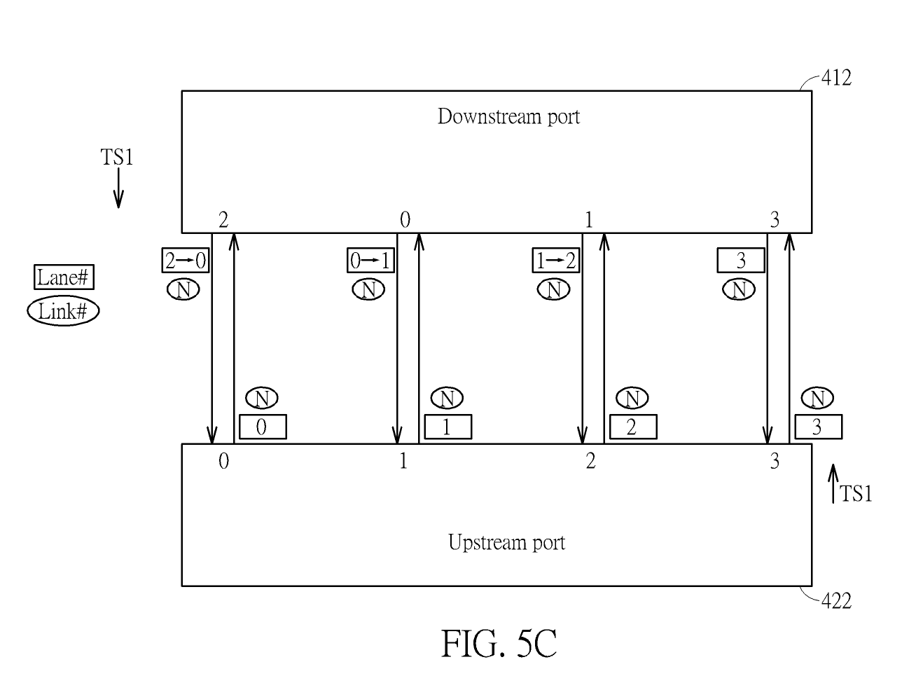

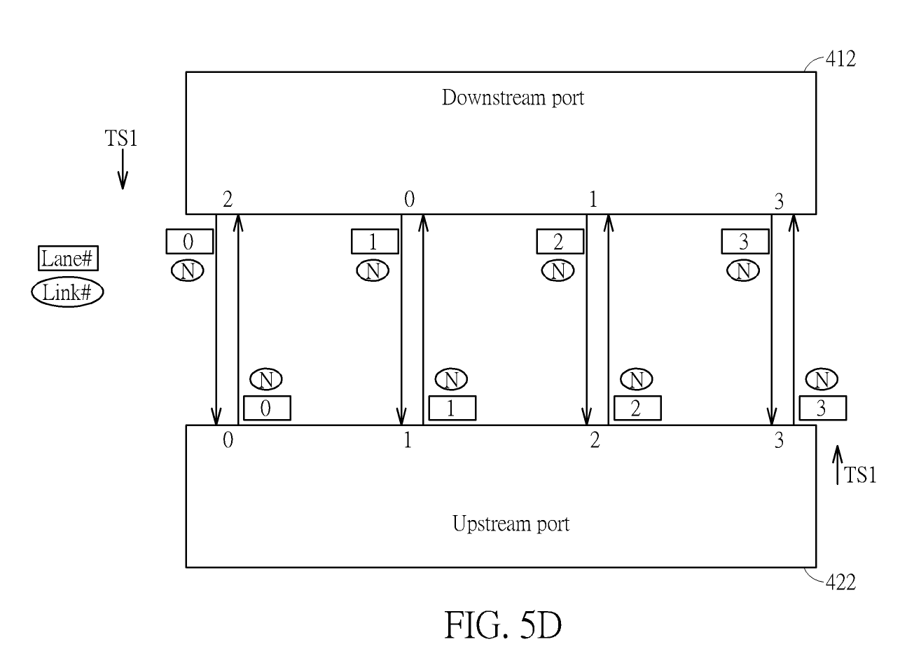

In FIG. 5A, the electronic device 410 starts the lane number negotiation with the electronic device 420. The control circuit 414 controls the downstream port 412 to transmit the training sequence TS1 to the upstream port 422 within the electronic device 420, wherein each training sequence TS1 comprises the link number “N” and a default lane number. For example, the first lane (from left to right) of the downstream port 412 transmits the training sequence TS1 having the link number “N” and a default lane number “2” to the first lane of the upstream port 422, the second lane of the downstream port 412 transmits the training sequence TS1 having the link number “N” and a default lane number “0” to the second lane of the upstream port 422, the third lane of the downstream port 412 transmits the training sequence TS1 having the link number “N” and a default lane number “1” to the third lane of the upstream port 422, and the fourth lane of the downstream port 412 transmits the training sequence TS1 having the link number “N” and a default lane number “3” to the fourth lane of the upstream port 422. At this time, each of the lanes of the upstream port 422 transmits the training sequence TS1 having the link number “N” and the lane number “PAD” to the downstream port 412.

In FIG. 5B, after receiving the training sequence TS1 from the downstream port 412, each lane the upstream port 422 transmits the training sequence TS1 having the link number “N” and its default lane number to the downstream port 412. In detail, the first lane of the upstream port 422 transmits the training sequence TS1 having the link number “N” and the default lane number “0” to the first lane of the downstream port 412, the second lane of the upstream port 422 transmits the training sequence TS1 having the link number “N” and the default lane number “1” to the second lane of the downstream port 412, the third lane of the upstream port 422 transmits the training sequence TS1 having the link number “N” and the default lane number “2” to third first lane of the downstream port 412, and the fourth lane of the upstream port 422 transmits the training sequence TS1 having the link number “N” and the default lane number “3” to the fourth lane of the downstream port 412.

In FIG. 5C, after receiving the training sequence TS1 from the upstream port 422, because the received lane number is different from the default lane number for some of the lanes, the control circuit 414 controls the lanes of the downstream port 412 to transmit the received lanes numbers, instead of the default lane numbers, to the upstream port 422. In detail, the first lane of the downstream port 412 transmits the training sequence TS1 having the link number “N” and the received lane number “0” to the first lane of the upstream port 422, the second lane of the downstream port 412 transmits the training sequence TS1 having the link number “N” and received lane number “1” to the second lane of the upstream port 422, the third lane of the downstream port 412 transmits the training sequence TS1 having the link number “N” and received lane number “2” to the third lane of the upstream port 422, and the fourth lane of the downstream port 412 transmits the training sequence TS1 having the link number “N” and the received lane number “3” to the fourth lane of the upstream port 422.

In FIG. 5D, because the electronic device 410 and 420 transmit and receive the same lane number sequence (i.e., “0”, “1”, “2”, and “3” from left to right), the lane numbers are confirmed and the lane number negotiation succeeds.

In addition, because the actual lane number sequence of the downstream port 412 is different from the default lane number sequence, the control circuit 414 needs to use the confirmed lane number sequence, instead of the default lane number sequence, to organize/process data received from the upstream port 422.

In the aforementioned embodiment, because the electronic device 410 has the auto-tuning mechanism of the present invention, the actual lane number of each lane of the downstream port 412 can be determined according to the received lane number, without being limited by the default lane number. Therefore, the PCB routing between the electronic devices 410 and 420 can be flexible.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An electronic device, comprising:
an upstream port comprising a plurality of lanes, wherein the plurality of lanes are used to couple to a plurality of lanes of a downstream port of another electronic device, respectively;
a control circuit coupled to the upstream port, for controlling a data transmission and data reception of the upstream port;
wherein when the lanes of the upstream port receive training sequences having a plurality of lane numbers from the lanes of the downstream port, respectively, to initiate a lane number negotiation, the lanes of the upstream port send back the received lane numbers to the downstream port, without considering default lane numbers of the lanes of the upstream port.

2. The electronic device of claim 1, wherein the default lane number of at least one lane of the upstream port is different from the lane number of the corresponding lane of the downstream port.

3. The electronic device of claim 2, wherein after the at least one lane of the upstream port receives the lane number of the corresponding lane of the downstream port, the upstream port sends back the received lane number, instead of the default lane number, to the corresponding lane of the downstream port.

4. The electronic device of claim 1, after the lane number negotiation succeeds, the control circuit uses the received lane numbers, without using the default lane number, to organize/process data received from the downstream port.

5. The electronic device of claim 1, wherein the upstream port is complied with Peripheral Component Interconnect (PCI), PCI-express (PCIe) or PCIe over MPHY (mPCIe) standard.

6. A method for communicating with another electronic device, comprising:
providing an upstream port comprising a plurality of lanes, wherein the plurality of lanes are used to couple to a plurality of lanes of a downstream port of the another electronic device, respectively;
receiving training sequences having a plurality of lane numbers from the lanes of the downstream port to initiate a lane number negotiation; and
sending back the received lane numbers to the downstream port, without considering default lane numbers of the lanes of the upstream port.

7. The method of claim 6, wherein the default lane number of at least one lane of the upstream port is different from the lane number of the corresponding lane of the downstream port.

8. The method of claim 7, wherein the step of sending back the received lane numbers to the downstream port comprises:
sending back the received lane number, instead of the default lane number, to the corresponding lane of the downstream port.

9. The method of claim 6, further comprising:
after the lane number negotiation succeeds, using the received lane numbers, without using the default lane number, to organize/process data received from the downstream port.

10. The method of claim 6, wherein the upstream port is complied with Peripheral Component Interconnect (PCI), PCI-express (PCIe) or PCIe over MPHY (mPCIe) standard.

11. An electronic device, comprising:
a downstream port comprising a plurality of lanes, wherein the plurality of lanes are used to couple to a plurality of lanes of an upstream port of another electronic device, respectively;
a control circuit coupled to the downstream port, for controlling a data transmission and data reception of the upstream port;
wherein when the lanes of the downstream port receive training sequences having a plurality of lane numbers from the lanes of the upstream port, respectively, the lanes of the downstream port send back the received lane numbers to the upstream port, without considering default lane numbers of the lanes of the downstream port.

12. The electronic device of claim 11, wherein the downstream port transmits training sequences having a plurality of default lane numbers to the upstream port to initiate a lane number negotiation, and for any one of the lanes of the downstream port: if the lane receives the training sequence having the lane number that is different from its own default lane number from the upstream port, the lane sends the received lane number, without sending the default lane number, to the upstream port to continue the lane number negotiation.

13. The method of claim 11, wherein the default lane number of at least one lane of the downstream port is different from the lane number of the corresponding lane of the upstream port.

14. The electronic device of claim 11, after the lane number negotiation succeeds, the control circuit uses the received lane numbers, without using the default lane number, to organize/process data received from the upstream port.

15. The electronic device of claim 11, wherein the downstream port is complied with Peripheral Component Interconnect (PCI), PCI-express (PCIe) or PCIe over MPHY (mPCIe) standard.

16. A method for communicating with another electronic device, comprising:
providing a downstream port comprising a plurality of lanes, wherein the plurality of lanes are used to couple to a plurality of lanes of an upstream port of another electronic device, respectively;
receiving training sequences having a plurality of lane numbers from the lanes of the upstream port, respectively; and
sending back the received lane numbers to the upstream port, without considering default lane numbers of the lanes of the downstream port.

17. The method of claim 16, further comprising:
transmitting training sequences having a plurality of default lane numbers to the upstream port to initiate a lane number negotiation; and
the step of sending back the received lane numbers to the upstream port comprises:
for any one of the lanes of the downstream port: if the lane receives the training sequence having the lane number that is different from its own default lane number from the upstream port, using the lane to send the received lane number, without sending the default lane number, to the upstream port to continue the lane number negotiation.

18. The method claim 16, wherein the default lane number of at least one lane of the downstream port is different from the lane number of the corresponding lane of the upstream port.

19. The method of claim 16, further comprising:
after the lane number negotiation succeeds, using the received lane numbers, without using the default lane number, to organize/process data received from the upstream port.

20. The method of claim 16, wherein the downstream port is complied with Peripheral Component Interconnect (PCI), PCI-express (PCIe) or PCIe over MPHY (mPCIe) standard.
